(19) United States
(12) Patent Application Publication
(10) Pub. No.: US 2023/0415102 A1
(43) Pub. Date: Dec. 28, 2023

(54) SEPARATION MEMBRANE COMPLEX AND METHOD OF PRODUCING SEPARATION MEMBRANE COMPLEX

(71) Applicant: NGK INSULATORS, LTD., Nagoya-City (JP)

(72) Inventors: Makoto MIYAHARA, Tajimi-City (JP); Kenichi NODA, Nagoya-City (JP)

(73) Assignee: NGK INSULATORS, LTD., Nagoya-City (JP)

(21) Appl. No.: 18/466,145

(22) Filed: Sep. 13, 2023

Related U.S. Application Data
(63) Continuation of application No. PCT/JP2021/043642, filed on Nov. 29, 2021.

(30) Foreign Application Priority Data
Mar. 31, 2021 (JP) 2021-060419

(51) Int. Cl. B01D 69/12; B01D 69/02; B01D 71/02; B01D 69/10; B01D 67/00; B01D 71/70

(52) U.S. Cl. CPC B01D 69/12; B01D 69/02; B01D 71/0281; B01D 69/108; B01D 67/00793; B01D 71/70; B01D 2325/02831; B01D 2325/02832; B01D 2325/04

(57) ABSTRACT

A separation membrane complex includes a porous support, an intermediate membrane which is a polycrystalline membrane formed on a surface of the support and has pores that are originated from a framework structure and have an average pore diameter smaller than that of pores in the vicinity of the surface of the support, and a separation membrane which is formed on the intermediate membrane and is an inorganic membrane having a regular pore structure. In the separation membrane, a functional group is introduced into pores of a surface layer thereof which is away from the intermediate membrane.

### CROSS-REFERENCE TO RELATED APPLICATIONS

The present application is a continuation application of International Application No. PCT/JP2021/043642 filed on Nov. 29, 2021, which claims priority to Japanese Patent Application No. 2021-060419 filed on Mar. 31, 2021. The contents of these applications are incorporated herein by reference in their entirety.

### TECHNICAL FIELD

The present invention relates to a separation membrane complex and a method of producing a separation membrane complex.

### BACKGROUND ART

In recent years, separation of carbon dioxide (CO₂) or the like by using mesoporous material such as mesoporous silica or the like has been proposed. A precursor solution which is a raw material of the mesoporous material has high fluidity since an organic solvent such as ethanol, IPA, or the like is used in general. Therefore, when a membrane of mesoporous material is formed on a porous support, the precursor solution infiltrates into the porous support and it becomes very difficult to form a membrane.

Then, in Japanese Patent Publication No. 4212581 (Document 1), as preprocessing of formation of a mesoporous silica thin membrane, proposed is a method of impregnating liquid paraffin into pores of the porous support. On the porous support in which the liquid paraffin is impregnated, a precursor solution is applied by the spin coat method and a gel thin membrane is thereby formed. Subsequently, the liquid paraffin and a surface active agent in the gel thin membrane are removed by firing, and a mesoporous silica membrane is thereby obtained. After that, by using a silane coupling agent having a basic functional group, the basic functional group is introduced into the mesoporous silica membrane.

When a mesoporous silica membrane is formed on a porous support of tube type, monolith type, or the like, the spin coat method cannot be used due to shape issues. Further, when the method of impregnating the liquid paraffin into such a porous support is adopted, it is not easy to impregnate the liquid paraffin into the entire porous support, and there arises a great variation (unevenness) in the thickness of the mesoporous silica membrane. As a result, there occurs a defect such as poor coverage or the like of the mesoporous silica membrane. This problem can arise also in a case of forming a separation membrane other than the mesoporous silica membrane.

Further, in the mesoporous silica membrane shown in Document 1, the separation performance of CO₂ becomes high by introduction of the basic functional group, but it is thought that the basic functional group is introduced into almost entire pores, and the permeance of CO₂ is reduced. The same problem can also occur in a case of introducing a functional group adsorbing any substance other than CO₂.

### SUMMARY OF THE INVENTION

The present invention is intended for a separation membrane complex, and it is an object of the present invention to appropriately form a separation membrane on a porous support and increase permeance of a predetermined substance in the separation membrane in which a functional group is introduced.

The separation membrane complex according to one preferred embodiment of the present invention includes a porous support, an intermediate membrane which is a polycrystalline membrane formed on a surface of the support and has pores originated from a framework structure, the pores having an average pore diameter smaller than that of pores in vicinity of the surface of the support, and a separation membrane which is formed on the intermediate membrane and is an inorganic membrane having a regular pore structure. In the separation membrane, a functional group is introduced into pores of a surface layer which is away from the intermediate membrane.

According to the present invention, it is possible to appropriately form a separation membrane on a porous support and increase permeance of a predetermined substance in the separation membrane in which a functional group is introduced.

Preferably, the average pore diameter of the intermediate membrane is 0.1 to 1.0 nm, an average pore diameter of the separation membrane is 0.5 to 10.0 nm, and the average pore diameter of the intermediate membrane is smaller than that of the separation membrane.

Preferably, the intermediate membrane is a membrane composed of zeolite or metal organic framework.

Preferably, the separation membrane is a membrane composed of mesoporous material, zeolite, or metal organic framework.

Preferably, in an X-ray diffraction pattern obtained by X-ray irradiation onto a surface of the separation membrane, a peak appears in a range of 2θ=1 to 4°.

Preferably, a thickness of the intermediate membrane is not larger than 5 μm and that of the separation membrane is not larger than 1 μm.

Preferably, the functional group is an amino group.

The present invention is also intended for a method of producing a separation membrane complex. The method of producing a separation membrane complex according to one preferred embodiment of the present invention includes a) preparing a porous support, b) forming an intermediate membrane on a surface of the support, the intermediate membrane being a polycrystalline membrane and having pores originated from a framework structure, the pores having an average pore diameter smaller than that of pores in vicinity of the surface of the support, c) forming a separation membrane on the intermediate membrane, the separation membrane being an inorganic membrane having a regular pore structure, and d) introducing a functional group into pores of a surface layer in the separation membrane by supplying a predetermined solution to the separation membrane, the surface layer being away from the intermediate membrane. The intermediate membrane has impermeability to a precursor solution used for forming the separation membrane in the operation c) and the predetermined solution used in the operation d).

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a cross-sectional view of a separation membrane complex;

FIG. 2 is a cross-sectional view enlargedly showing part of the separation membrane complex;

FIG. 3 is a flowchart showing a flow for producing the separation membrane complex;

FIG. 4 is a view showing a separation apparatus; and

FIG. 5 is a flowchart showing a flow for separating a mixed substance.

### DETAILED DESCRIPTION

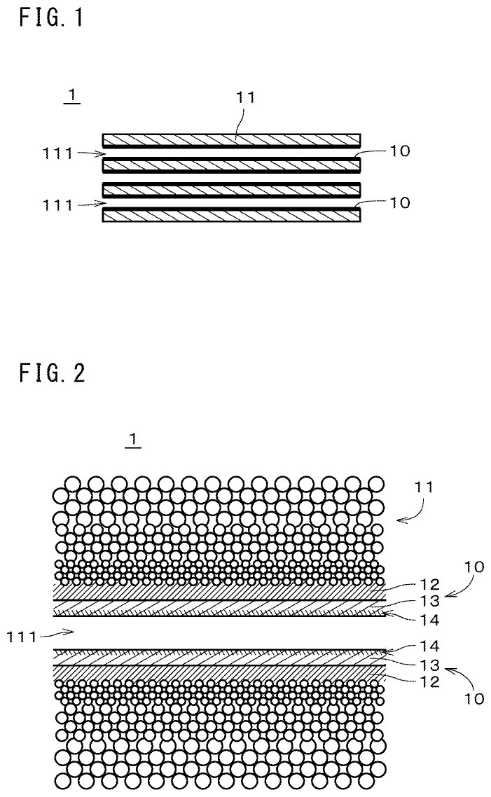

FIG. 1 is a cross-sectional view of a separation membrane complex 1. FIG. 2 is a cross-sectional view enlargedly showing part of the separation membrane complex 1. The separation membrane complex 1 includes a porous support 11 and a laminated membrane 10 formed on the support 11. In FIG. 1, the laminated membrane 10 is represented by a thick line. The laminated membrane 10 includes an intermediate membrane 12 and a separation membrane 13. The intermediate membrane 12 is formed on the support 11, and the separation membrane 13 is formed on the intermediate membrane 12. In FIG. 2, the intermediate membrane 12 and the separation membrane 13 are hatched. Further, in FIG. 2, the respective thicknesses of the intermediate membrane 12 and the separation membrane 13 are shown larger than the actual ones.

The support 11 is a porous member that gas and liquid can permeate. In the exemplary case shown in FIG. 1, the support 11 is a monolith-type support having an integrally and continuously molded columnar main body with a plurality of through holes 111 extending in a longitudinal direction (i.e., a left and right direction in FIG. 1). In the exemplary case shown in FIG. 1, the support 11 has a substantially columnar shape. A cross section of each of the through holes 111 (i.e., cells), which is perpendicular to the longitudinal direction, is, for example, substantially circular. In FIG. 1, the diameter of each through hole 111 is larger than the actual diameter, and the number of through holes 111 is smaller than the actual number. The laminated membrane 10 is formed on an inner surface of the through hole 111, covering substantially the entire inner surface of the through hole 111.

The length of the support 11 (i.e., the length in the left and right direction of FIG. 1) is, for example, 10 cm to 200 cm. The outer diameter of the support 11 is, for example, 0.5 cm to 30 cm. The distance between the central axes of adjacent through holes 111 is, for example, 0.3 mm to 10 mm. The surface roughness (Ra) of the support 11 is, for example, 0.1 μm to 5.0 μm, and preferably 0.2 μm to 2.0 μm. Further, the shape of the support 11 may be, for example, honeycomb-like, flat plate-like, tubular, cylindrical, columnar, polygonal prismatic, or the like. When the support 11 has a tubular or cylindrical shape, the thickness of the support 11 is, for example, 0.1 mm to 10 mm.

As the material for the support 11, various materials (for example, ceramics or a metal) may be adopted only if the materials ensure chemical stability in the process step of forming the laminated membrane 10 on the surface thereof. In the present preferred embodiment, the support 11 is formed of a ceramic sintered body. Examples of the ceramic sintered body which is selected as a material for the support 11 include alumina, silica, mullite, zirconia, titania, yttria, silicon nitride, silicon carbide, and the like. In the present preferred embodiment, the support 11 contains at least one type of alumina, silica, and mullite.

The support 11 may contain an inorganic binder. As the inorganic binder, at least one of titania, mullite, easily sinterable alumina, silica, glass frit, a clay mineral, and easily sinterable cordierite can be used.

The average pore diameter of the support 11 is, for example, 0.01 μm to 70 μm, and preferably 0.05 μm to 25 μm. The average pore diameter of the support 11 in the vicinity of the surface on which the laminated membrane 10 is formed is 0.01 μm to 1 μm, and preferably 0.05 μm to 0.5 μm. The average pore diameter can be measured by using, for example, a mercury porosimeter, a perm porometer, or a nano-perm porometer. Regarding the pore diameter distribution of the entire support 11 including the surface and the inside thereof, D5 is, for example, 0.01 μm to 50 μm, D50 is, for example, 0.05 μm to 70 μm, and D95 is, for example, 0.1 μm to 2000 μm. The porosity of the support 11 in the vicinity of the surface on which the laminated membrane 10 is formed is, for example, 20% to 60%.

The support 11 has, for example, a multilayer structure in which a plurality of layers with different average pore diameters are layered in a thickness direction. The average pore diameter and the sintered grain diameter in a surface layer including the surface on which the laminated membrane 10 is formed are smaller than those in layers other than the surface layer. The average pore diameter in the surface layer of the support 11 is, for example, 0.01 μm to 1 μm, and preferably 0.05 μm to 0.5 μm. When the support 11 has a multilayer structure, the materials for the respective layers can be those described above. The materials for the plurality of layers constituting the multilayer structure may be the same as or different from one another.

As described earlier, the laminated membrane 10 includes the intermediate membrane 12 formed on the surface of the support 11 and the separation membrane 13 formed on the intermediate membrane 12. The intermediate membrane 12 is a polycrystalline membrane and a porous membrane having pores (micropores) originated from a framework structure of crystals. The intermediate membrane 12 is a membrane composed of zeolite or metal organic framework (MOF). The membrane composed of zeolite or MOF is obtained at least by forming zeolite or MOF on the surface of the support 11 in a membrane form and does not include a membrane obtained by simply dispersing zeolite particles or MOF particles in an organic membrane. The intermediate membrane 12 may be formed of any substance other than the zeolite or the MOF.

The thickness of the intermediate membrane 12 is, for example, 0.05 μm to 30 μm. The thickness of the intermediate membrane 12 is preferably not larger than 5 μm, more preferably not larger than 4 μm, and further preferably not larger than 3 μm. The thickness of the intermediate membrane 12 is preferably not smaller than 0.1 μm, and more preferably not smaller than 0.5 μm. The thickness of the intermediate membrane 12 can be measured by, for example, imaging a cross section perpendicular to the intermediate membrane 12 by the scanning electron microscope (SEM) or the field emission scanning electron microscope (FE-SEM) (the same applies to the thickness of the separation membrane 13 described later).

The average pore diameter of the intermediate membrane 12 is preferably not larger than 1.0 nm, more preferably not larger than 0.8 nm, and further preferably not larger than 0.6 nm. The average pore diameter of the intermediate membrane 12 is preferably not smaller than 0.1 nm, more preferably not smaller than 0.2 nm, and further preferably not smaller than 0.3 nm. The average pore diameter of the intermediate membrane 12 is smaller than that of the support 11 in the vicinity of the surface on which the intermediate membrane 12 is formed. In the later-described production of the separation membrane complex 1, when a precursor solution for formation of the separation membrane 13 does not permeate the intermediate membrane 12, the average pore diameter of the intermediate membrane 12 may be larger than 1.0 nm.

A preferably intermediate membrane 12 is a membrane composed of zeolite. When the maximum number of membered rings of the zeolite is n, an arithmetic average of the short diameter and the long diameter of an n-membered ring pore is defined as the average pore diameter. The n-membered ring pore refers to a pore in which the number of oxygen atoms in the part where the oxygen atoms and T atoms are bonded to form a ring structure is n. When the zeolite has a plurality of kinds of n-membered ring pores having the same n, an arithmetic average of the short diameters and the long diameters of all the kinds of the n-membered ring pores is defined as the average pore diameter of the zeolite. Thus, the average pore diameter of the zeolite membrane is uniquely determined depending on the framework structure of the zeolite and can be obtained from values disclosed in “Database of Zeolite Structures” [online], internet <URL: http://www.iza-structure.org/databases/> of the International Zeolite Association.

There is no particular limitation on the type of the zeolite composing the intermediate membrane 12, but the intermediate membrane 12 may be composed of, for example, AEI-type, AEN-type, AFN-type, AFV-type, AFX-type, BEA-type, CHA-type, DDR-type, ERI-type, ETL-type, FAU-type (X-type, Y-type), GIS-type, LEV-type, LTA-type, MEL-type, MER-type, MFI-type, MOR-type, PAU-type, RHO-type, SAT-type, SOD-type, SZR-type zeolite, or the like. The intermediate membrane 12 is composed of, for example, DDR-type zeolite. In other words, the intermediate membrane 12 is a zeolite membrane composed of the zeolite having a structure code of “DDR” which is designated by the International Zeolite Association. In this case, the unique pore diameter of the zeolite composing the intermediate membrane 12 is 0.36 nm×0.44 nm, and the average pore diameter is 0.40 nm.

When the intermediate membrane 12 is a zeolite membrane, the intermediate membrane 12 contains, for example, silicon (Si). The intermediate membrane 12 may contain, for example, any two or more of Si, aluminum (Al), and phosphorus (P). In this case, as the zeolite composing the intermediate membrane 12, zeolite in which atoms (T-atoms) each located at the center of an oxygen tetrahedron (TO₄) constituting the zeolite include only Si or Si and Al, AlPO-type zeolite in which T-atoms include Al and P, SAPO-type zeolite in which T-atoms include Si, Al, and P, MAPSO-type zeolite in which T-atoms include magnesium (Mg), Si, Al, and P, ZnAPSO-type zeolite in which T-atoms include zinc (Zn), Si, Al, and P, or the like can be used. Some of the T-atoms may be replaced by other elements.

When the intermediate membrane 12 contains Si atoms and Al atoms, the ratio of Si/Al in the intermediate membrane 12 is, for example, not less than 1 and not more than 100,000. The Si/Al ratio is preferably 5 or more, more preferably 20 or more, and further preferably 100 or more. In short, the higher the ratio is, the better. By adjusting the mixing ratio of an Si source and an Al source in a later-described starting material solution, or the like, it is possible to adjust the Si/Al ratio in the intermediate membrane 12. The intermediate membrane 12 may contain an alkali metal. The alkali metal is, for example, sodium (Na) or potassium (K).

Also in the case where the intermediate membrane 12 is a membrane composed of MOF, similarly, the average pore diameter of the intermediate membrane 12 can be calculated from the framework structure of the crystals. The type of the MOF composing the intermediate membrane 12 and the elements composing the MOF are not particularly limited.

The separation membrane 13 is an inorganic membrane having a regular pore structure. The regular pore structure typically refers to a structure having almost uniform pore diameters, and preferably a structure having pore diameters that show a pore diameter distribution included in a narrow range of 0.5 nm to 10 nm (for example, 90% or more of pores are included in this range). The separation membrane 13 is, for example, a membrane composed of mesoporous material, zeolite, or MOF. The membrane composed of mesoporous material, zeolite, or MOF is a membrane obtained at least by forming the mesoporous material, the zeolite, or the MOF in a membrane form on the intermediate membrane 12 and does not include a membrane obtained by simply dispersing mesoporous material particles, zeolite particles, or MOF particles in an organic membrane. The separation membrane 13 may be formed of any substance other than the mesoporous material, the zeolite or the MOF. The separation membrane 13 can be used as a membrane to be used for separating a specific substance from a mixed substance containing a plurality of types of substances, by using a molecular sieving function. As compared with the specific substance, any one of the other substances is harder to permeate the separation membrane 13. In other words, the permeance of any other substance through the separation membrane 13 is smaller than that of the above specific substance.

The thickness of the separation membrane 13 is smaller than, for example, that of the intermediate membrane 12. The thickness of the separation membrane 13 may be not smaller than that of the intermediate membrane 12. The thickness of the separation membrane 13 is preferably not larger than 1 μm, more preferably not larger than 0.5 μm, and further preferably not larger than 0.3 μm. When the thickness of the separation membrane 13 is reduced, the permeance of the above-described specific substance increases. The thickness of the separation membrane 13 is preferably not smaller than 0.1 μm, and more preferably not smaller than 0.2 μm. When the thickness of the separation membrane 13 is increased, the separation performance increases. The surface roughness (Ra) of the separation membrane 13 is, for example, 1 μm or less, preferably 0.5 μm or less, and more preferably 0.3 μm or less.

The average pore diameter of the separation membrane 13 is preferably not larger than 10.0 nm, more preferably not larger than 8.0 nm, and further preferably not larger than 5.0 nm. The average pore diameter of the separation membrane 13 is preferably not smaller than 0.5 nm, more preferably not smaller than 1.0 nm, and further preferably not smaller than 2.0 nm. The average pore diameter of the separation membrane 13 is, for example, larger than that of the intermediate membrane 12. The average pore diameter of the separation membrane 13 may be not larger than that of the intermediate membrane 12.

A preferable separation membrane 13 is an amorphous membrane composed of oxide such as mesoporous silica or the like or mesoporous carbon. Since mesoporous silica or mesoporous carbon is formed by using a micelle which is a surface active agent as a mold, the average pore diameter depends on the type of surface active agent to be used. The average pore diameter is an arithmetic average of the short diameter and the long diameter of the pores. When the separation membrane 13 is a membrane composed of mesoporous silica or mesoporous carbon, the average pore diameter of the pores is, for example, 0.5 nm to 10.0 nm. The average pore diameter of the separation membrane 13 can be measured by using the transmission electron microscope (TEM).

When the separation membrane 13 is composed of mesoporous silica or mesoporous carbon, in an X-ray diffraction (XRD) pattern obtained by X-ray irradiation onto a surface of the separation membrane 13, a peak derived from the regular pore structure of the separation membrane 13 appears in a range of diffraction angle 2θ=1 to 4°. In other words, since the peak appears in the range of 2θ=1 to 4° in the X-ray diffraction pattern, the separation membrane 13 has a regular pore structure having a preferable size. Further, for acquisition of the X-ray diffraction pattern, for example, a CuKα ray is used as a radiation source of an X-ray diffraction apparatus.

The separation membrane 13 may be a membrane in which no peak appears in the range of 2θ=1 to 4° in the X-ray diffraction pattern. When the separation membrane 13 is a membrane composed of zeolite or MOF, for example, the above-described peak does not typically appear in the X-ray diffraction pattern. The separation membrane 13 which is a zeolite membrane or a MOF membrane is a polycrystalline membrane and has pores originated from the framework structure of the crystals. Such a separation membrane 13 is also a membrane having almost uniform pore diameters and a regular pore structure.

In the separation membrane 13, in a surface layer 14 away from the intermediate membrane 12, surfaces of the pores are modified by a functional group which adsorbs a predetermined substance (e.g., CO₂). Specifically, the surface layer 14 including the surface of the separation membrane 13 serves as a functional group introduction layer 14 in which a functional group is introduced into the pores. The functional group introduction layer 14 can be regarded as an organic-inorganic hybrid layer in which an organic functional group is compounded into the separation membrane 13 which is an inorganic membrane. The functional group to be introduced into the functional group introduction layer 14 is, for example, an amino group. In FIG. 2, the functional group introduction layer 14 in the separation membrane 13 is indicated by parallel hatch lines intersecting those for the separation membrane 13.

In the separation membrane 13, the functional group introduction layer 14 is formed only on the surface side of the separation membrane 13 and is not formed on the side of the intermediate membrane 12. In other words, the functional group introduction layer 14 (functional group) exists one-sidedly on the surface side. Though the reason why such a functional group introduction layer 14 is formed is not clear, one cause is thought to be that a solution for introduction of the functional group used in the later-described production of the separation membrane complex 1 cannot permeate the pores of the intermediate membrane 12. If the functional group is introduced into the entire pores of the separation membrane, since a substance adsorbed to the functional group permeates the separation membrane by repeating adsorption to and desorption from the functional group, the permeation resistance of the substance increases and the permeance is reduced. In contrast to this, in the separation membrane complex 1, since the functional group introduction layer 14 is formed only on the surface side of the separation membrane 13, the permeation resistance of the substance becomes lower and the permeance increases.

The existence of the functional group introduction layer 14 can be confirmed by, for example, the D-SIMS (Dynamic-SIMS). Though C and H detect moistures or the like, as to a silane coupling agent containing, for example, an amino group, the support amount can be measured by measuring N element.

In the D-SIMS, the concentration of an element (hereinafter, referred to as a “specific element”) contained in the functional group in the functional group introduction layer 14 and not contained in the separation membrane 13 (except the functional group) nor the intermediate membrane 12 is measured in a depth direction from the surface of the separation membrane 13. Then, in a case where the concentration of the specific element gradually decreases (is inclined) from the surface of the separation membrane 13 toward the intermediate membrane 12 and becomes almost constant before reaching an interface with the intermediate membrane 12, it can be said that the functional group introduction layer 14 is formed only on the surface side of the separation membrane 13 and not formed on the side of the intermediate membrane 12 in the separation membrane 13. Further, since the concentration of the specific element in the very vicinity of the surface of the separation membrane 13 may be affected by contamination, the concentration may be ignored. When it is assumed that the distance from the surface of the separation membrane 13 to a position where the concentration of the specific element becomes almost constant is the thickness of the functional group introduction layer 14, the thickness of the functional group introduction layer 14 is preferably not more than 0.7 times the thickness of the separation membrane 13, and more preferably not more than 0.5 times the thickness of the separation membrane 13. The thickness of the functional group introduction layer 14 is, for example, not less than 0.1 times the thickness of the separation membrane 13.

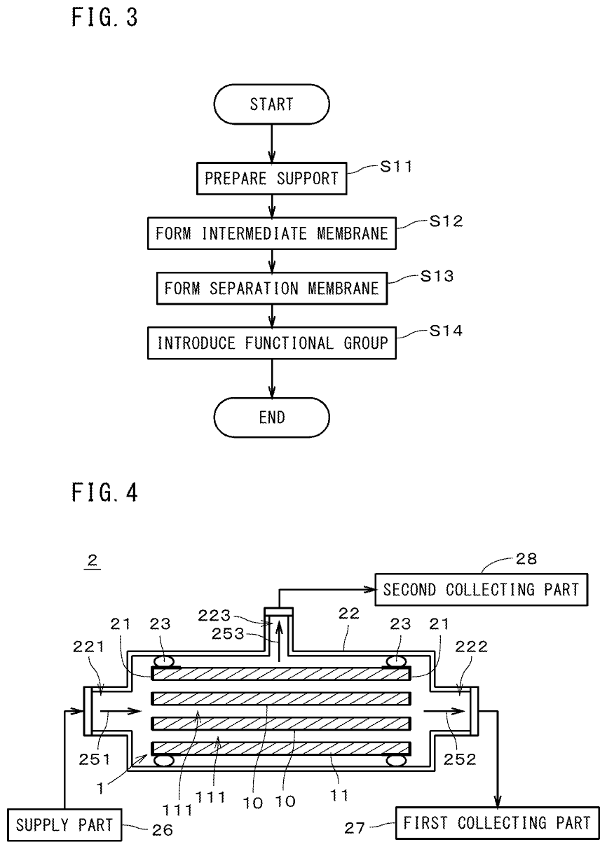

Next, with reference to FIG. 3, an exemplary flow for producing the separation membrane complex 1 will be described. Hereinafter, though an exemplary case where a zeolite membrane is formed as the intermediate membrane 12 and a mesoporous silica membrane is formed as the separation membrane 13 will be described, if any other types of membranes are formed as the intermediate membrane 12 and the separation membrane 13, the same process as shown in FIG. 3 is performed by using a well-known method of forming the membranes.

In the production of the separation membrane complex 1, first, the porous support 11 is prepared (Step S11). Further, seed crystals to be used for production of the zeolite membrane are prepared. In one exemplary case where a DDR-type zeolite membrane is formed as the intermediate membrane 12, DDR-type zeolite powder is synthesized by hydrothermal synthesis, and the seed crystals are acquired from the zeolite powder. The zeolite powder itself may be used as the seed crystals, or may be processed by pulverization or the like, to thereby acquire the seed crystals.

Subsequently, the support 11 is immersed in a dispersion liquid in which the seed crystals are dispersed, and the seed crystals are thereby deposited onto the support 11. Alternatively, the dispersion liquid in which the seed crystals are dispersed is brought into contact with a portion on the support 11 where the intermediate membrane 12 is to be formed, and the seed crystals are thereby deposited onto the support 11. A support with seed crystals deposited is thereby produced. The seed crystals may be deposited onto the support 11 by any other method.

The support 11 on which the seed crystals are deposited is immersed in the starting material solution. The starting material solution is produced by dissolving or dispersing, for example, an Si source, a structure-directing agent (hereinafter, also referred to as an “SDA”), or the like in a solvent. The Si source is, for example, colloidal silica, sodium silicate, fumed silica, alkoxide, or the like. The SDA contained in the starting material solution is, for example, an organic substance. The SDA is, for example, 1-adamantanamine. The solvent is, for example, water. Then, the DDR-type zeolite is caused to grow from the seed crystals as nuclei by the hydrothermal synthesis, to thereby form the DDR-type zeolite membrane as the intermediate membrane 12 on the support 11. The temperature in the hydrothermal synthesis is, for example, 80 to 200° C. The time for hydrothermal synthesis is, for example, 3 to 100 hours.

After the hydrothermal synthesis is finished, the support 11 and the intermediate membrane 12 are washed with pure water. The support 11 and the intermediate membrane 12 after being washed are dried at, for example, 80° C. After drying of the support 11 and the intermediate membrane 12 is finished, a heat treatment is performed under an oxidizing gas atmosphere, to thereby burn and remove the SDA in the intermediate membrane 12. This allows micropores in the intermediate membrane 12 to go through the intermediate membrane 12. Preferably, the SDA is almost completely removed. The heating temperature for removing the SDA is, for example, from 300° C. to 700° C. The heating time is, for example, from 5 to 200 hours. The oxidizing gas atmosphere is an atmosphere containing oxygen and for example, the air.

Through the above-described process, the intermediate membrane 12 with the pores going therethrough is obtained (Step S12). The intermediate membrane 12 which is the zeolite membrane is a polycrystalline membrane and has pores originated from a framework structure. The average pore diameter of the pores in the intermediate membrane 12 is smaller than that of the pores in the vicinity of the surface of the support 11. Further, in the formation of the zeolite membrane, the process for depositing the seed crystals on the support 11 may be omitted, and in this case, the zeolite membrane is formed directly on the support 11.

Subsequently, the precursor solution for formation of the separation membrane 13 is prepared. The precursor solution is produced, for example, by dissolving a silica source, a surface active agent, an acid catalyst, or the like in the solvent. The silica source is, for example, tetraethyl orthosilicate (tetraethyltriethoxysilane) (TEOS), tetramethyl orthosilicate (TMOS), or the like. As the surface active agent, for example, a bromide, a chloride, or the like, such as cetyltrimethylammonium bromide (cetylmethylammonium bromide) (CTAB) or cetyltrimethylammonium chloride may be used, but the present invention is not limited to these. The acid catalyst is a pH adjuster, and is, for example, hydrochloric acid, nitric acid, sulfuric acid, or the like. As the pH adjuster, alkali may be used. The solvent is, for example, an organic solvent such as ethanol, isopropyl alcohol (IPA), or the like. The mixing ratio of compositions in the precursor solution is set as appropriate in accordance with the type or the like of the mesoporous silica membrane to be formed.

The precursor solution is supplied onto the intermediate membrane 12 of the support 11. At that time, since the intermediate membrane 12 has impermeability to the precursor solution, the precursor solution does not permeate through the pores of the intermediate membrane 12 and is deposited onto a surface of the intermediate membrane 12. In other words, a membrane of the precursor solution is formed on the surface of the intermediate membrane 12. It is preferable that the excessive precursor solution on the intermediate membrane 12 should be removed by, for example, air blow or the like. The solvent or the like in the precursor solution is also almost removed by air blow or the like. After that, a heat treatment is performed on the support 11 under an oxidizing gas atmosphere, to thereby burn and remove the surface active agent in the membrane on the intermediate membrane 12. The mesoporous silica membrane on the intermediate membrane 12 is thereby formed as the separation membrane 13 (Step S13). The separation membrane 13 has a regular pore structure. The heating temperature for removing the surface active agent is, for example, 300° C. to 600° C. The heating time is, for example, 1 to 100 hours. The oxidizing gas atmosphere is an atmosphere containing oxygen and for example, the air.

Herein, in a case where a separation membrane is formed on the support 11 where the intermediate membrane 12 is not formed, in other words, the precursor solution is directly supplied onto the support 11, the precursor solution infiltrates into (goes through) the pores of the support 11. As a result, in a surface of the support 11 where the separation membrane is to be formed, poor coverage occurs in which the mesoporous silica membrane (separation membrane) is partially not formed. In contrast to this, in the production of the separation membrane complex 1 shown in FIG. 3, the intermediate membrane 12 can prevent or suppress the precursor solution from infiltrating into the pores of the support 11, and the poor coverage due to the infiltration of the precursor solution does not occur and a uniform separation membrane 13 can be thereby formed.

After the separation membrane 13 is formed, a solution for introduction of the functional group is prepared. The solution for introduction of the functional group is used for introduction of a predetermined functional group and is, for example, a solution in which a silane coupling agent is dissolved in the solvent. The solution for introduction of the functional group is also termed a hybridization solution. The functional group adsorbs a predetermined substance (e.g., CO₂), and is, for example, a basic functional group having an amino group. The silane coupling agent is, for example, 3-aminopropyltriethoxysilane (APS), N1-(3-trimethoxysilylpropyl)diethylenetriamine, or the like. As a substance having a basic functional group other than the silane coupling agent, amine is used. The substance is, for example, ethylenediamine, 2-(2-aminoethylamino)ethanol, N-ethylethylenediamine, diethylenetriamine, isobutylamine, N-(2-aminoethyl)piperazine, or the like, or polyethyleneimine. The solvent is, for example, an organic solvent such as toluene, methanol, ethanol, isopropanol, acetone, tetrahydrofuran (THF), or the like.

The solution for introduction of the functional group is supplied to the separation membrane 13. In the present process example, by immersing the support 11 on which the separation membrane 13 is formed in the solution for introduction of the functional group of the room temperature, the solution is supplied to the separation membrane 13. The immersion time is, for example, 1 to 200 hours. At that time, the solution for introduction of the functional group can permeate the pores of the separation membrane 13 but cannot permeate the pores of the intermediate membrane 12. In other words, the separation membrane 13 has permeability to the solution for introduction of the functional group, and the intermediate membrane 12 has impermeability to the solution for introduction of the functional group. Therefore, the solution for introduction of the functional group infiltrates into the pores of the separation membrane 13 only from the surface side of the separation membrane 13 and does not infiltrate into the pores of the separation membrane 13 from the side of the intermediate membrane 12 (the side of the support 11). After the immersion time elapses, the support 11 is taken out from the solution for introduction of the functional group. In the separation membrane 13, the functional group is thereby introduced into the pores of the surface layer 14 away from the intermediate membrane 12 (Step S14). In other words, the organic-inorganic hybridization of the surface layer 14 in the separation membrane 13 is performed. Through the above-described process, the production of the separation membrane complex 1 is completed.

As described above, in the separation membrane complex 1, the intermediate membrane 12 is formed on the surface of the porous support 11, and the separation membrane 13 having a regular pore structure is formed on the intermediate membrane 12. The intermediate membrane 12 is a polycrystalline membrane and has the pores originated from the framework structure. Further, the average pore diameter of the pores is smaller than that of the pores in the vicinity of the surface of the support 11. Therefore, the intermediate membrane 12 prevents or suppresses the precursor solution for formation of the separation membrane from infiltrating into the pores of the support 11. As a result, it becomes possible to appropriately form the separation membrane 13 on the support 11 (uniformly form the separation membrane 13 having a thickness of, for example, 1 μm or less) while suppressing occurrence of the defect such as the poor coverage or the like. Further, in the separation membrane 13 which is an inorganic membrane, the functional group adsorbing a predetermined substance (e.g., CO₂) is introduced into the pores of the surface layer 14 away from the intermediate membrane 12. Since a range in which the functional group is introduced is limited to the surface side in the separation membrane 13, it is possible to increase the permeance of the substance while achieving high separation performance.

In the case where the functional group is an amino group, it is possible to increase the permeance of carbon dioxide while achieving high separation performance. The functional group may be one other than the amino group.

In a preferable separation membrane complex 1, the average pore diameter of the intermediate membrane 12 is 0.1 to 1.0 nm. In the intermediate membrane 12, it is thereby possible to more reliably prevent or suppress infiltration of the precursor solution and permeation of the solution for introduction of the functional group. Further, since the average pore diameter of the separation membrane 13 is not smaller than 0.5 nm, it is possible to achieve high permeance while modifying the inside of the pores with many functional groups. Furthermore, since the average pore diameter of the separation membrane 13 is not larger than 10.0 nm, it is possible to achieve high separation performance while modifying the inside of the pores with the functional group.

Preferably, the thickness of the intermediate membrane 12 is not larger than 5 μm and that of the separation membrane 13 is not larger than 1 km. It is thereby possible to more reliably increase the permeance of the predetermined substance.

Preferably, the intermediate membrane 12 is a membrane composed of zeolite or metal organic framework. It is thereby possible to easily achieve the intermediate membrane 12 which is a polycrystalline membrane and has pores originated from the framework structure. Further, in the intermediate membrane 12, it is possible to more reliably prevent or suppress infiltration of the precursor solution and permeation of the solution for introduction of the functional group.

Preferably, the separation membrane 13 is a membrane composed of mesoporous material, zeolite, or metal organic framework. It is thereby possible to easily achieve the separation membrane 13 having a regular pore structure. Further, it is preferable that, in the X-ray diffraction pattern obtained by X-ray irradiation onto the surface of the separation membrane 13, a peak should appear in a range of 2θ=1 to 4°. In this case, a preferable separation membrane 13 having a regular pore structure is achieved.

The method of producing the separation membrane complex 1 includes a step of preparing the porous support 11 (Step S11), a step of forming the intermediate membrane 12 on the surface of the support 11 (Step S12), a step of forming the separation membrane 13 on the intermediate membrane 12 (Step S13), and a step of introducing a functional group into the pores of the surface layer 14 in the separation membrane 13, which is away from the intermediate membrane 12 (Step S14). The intermediate membrane 12 has impermeability to the precursor solution used for forming the separation membrane 13 in Step S13 and the solution for introduction of the functional group used in Step S14. It is thereby possible to appropriately form the separation membrane 13 on the porous support 11. Further, it is possible to introduce the functional group only into the surface side in the separation membrane 13 and increase the permeance of a predetermined substance.

Next, Examples of the separation membrane complex will be described. Table 1 shows the type of intermediate membrane, the thickness of the intermediate membrane, the type of separation membrane, the thickness of the separation membrane, the type of basic functional group, the measurement result of the CO₂ permeance in Examples 1 to 10 and Comparative Example 1.

TABLE 1

| | | Thickness of | | Thickness of | | |
|---|---|---|---|---|---|---|
| | | Intermediate | | Separation | | |
| | Intermediate | Membrane | Separation | Membrane | | CO₂ Permeance |
| | Membrane | [μm] | Membrane | [μm] | Basic Functional Group | [mol/s · m² · Pa] |
| Example 1 | Zeolite | 1 | Mesoporous | 0.3 | 3-aminopropyltriethoxysilane | 1.1E−07 |
| | (DDR) | | Silica | | | |
| Example 2 | Zeolite | 1 | Mesoporous | 0.3 | N1-(3-trimethoxysilylpropyl)diethylenetriamine | 5.1E−08 |
| | (DDR) | | Silica | | | |
| Example 3 | Zeolite | 1 | Mesoporous | 0.3 | ethylenediamine | 2.1E−07 |
| | (DDR) | | Silica | | | |
| Example 4 | Zeolite | 1 | Mesoporous | 0.3 | 2-(2-aminoethylamino)ethanol | 1.5E−07 |
| | (DDR) | | Silica | | | |
| Example 5 | Zeolite | 5 | Mesoporous | 0.3 | 3-aminopropyltriethoxysilane | 4.0E−08 |
| | (MFI) | | Silica | | | |
| Example 6 | Zeolite | 5 | Mesoporous | 0.3 | 2-(2-aminoethylamino)ethanol | 1.0E−07 |
| | (MFI) | | Silica | | | |
| Example 7 | Zeolite | 1 | Mesoporous | 0.3 | 3-aminopropyltriethoxysilane | 9.0E−08 |
| | (BEA) | | Silica | | | |
| Example 8 | Zeolite | 3 | Mesoporous | 0.3 | 3-aminopropyltriethoxysilane | 3.5E−06 |
| | (FAU) | | Silica | | | |
| Example 9 | Zeolite | 1 | Mesoporous | 0.3 | diethylenetriamine | 1.6E−07 |
| | (DDR) | | Silica | | | |
| Example 10 | MOF | 10 | Mesoporous | 0.3 | 3-aminopropyltriethoxysilane | 8.0E−09 |
| | (UiO-66) | | Silica | | | |
| Comparative | — | — | Mesoporous | 10 | 3-aminopropyltriethoxysilane | 4.0E−09 |
| Example 1 | | | Silica | (Infiltrate into | | |
| | | | | Support) | | |

### Example 1

(Formation of Intermediate Membrane (DDR-type Zeolite Membrane))

A monolith-type alumina porous support is prepared and seed crystals of DDR-type zeolite are deposited on the inner surface of each through hole. Next, by mixing colloidal silica, 1-adamantanamine, ethylenediamine, and water, a starting material solution is prepared. The ratio of silica, 1-adamantanamine, ethylenediamine, and water is 1:1:0.25:100 at the molar ratio. After placing the alumina porous support on which the seed crystals of DDR-type zeolite are deposited into a fluororesin inner cylinder (internal volume: 300 ml) of a stainless pressure-resistant container, the above-described starting material solution is put therein and a heat treatment (hydrothermal synthesis at 130° C. for 24 hours) is performed, to thereby form a high silica DDR-type zeolite membrane on the inner surface of the through hole. Next, the alumina support is washed and then dried at 80° C. for 12 hours or more. After that, by raising the temperature of the alumina support to 450° C. in the electric furnace and keeping the temperature thereof for 50 hours, the organic substance (SDA) is burned and removed, and a DDR-type zeolite membrane which is the intermediate membrane is thereby obtained.

(Formation of Separation Membrane (Mesoporous Silica Membrane))

Tetraethyl orthosilicate (hereinafter, referred to as “TEOS”) as the silica source, cetyltrimethylammonium bromide (hereinafter, referred to as “CTAB”) as the surface active agent, hydrochloric acid as the acid catalyst, and ethanol (EtOH) as the solvent are prepared. TEOS and ethanol are mixed and water adjusted to have pH=1.25 with hydrochloric acid is added thereto, and then hydrolysis is performed. After that, CTAB is added thereto and dispersed by an ultrasonic washing machine. Further, additionally, ethanol is added, and a precursor solution having a molar ratio of 1 SiO₂:0.1 CTAB:5H₂O:11.8 EtOH is thereby obtained.

In the monolith-type porous support on which the zeolite membrane is formed, the precursor solution is poured into the inner surface of each through hole, and after that, the excessive precursor solution is blown off by air blow. By raising the temperature of the porous support to 450° C. in the electric furnace and keeping the temperature thereof for 50 hours, CATB is burned and removed, and a separation membrane complex in which the mesoporous silica membrane which is the separation membrane is formed on the zeolite membrane is thereby obtained.

(Organic-Inorganic Hybridization of Separation Membrane)

By mixing 3-aminopropyltriethoxysilane (APS) which is the silane coupling agent and toluene, the solution for introduction of the functional group is obtained. The above-described separation membrane complex is immersed in the solution and kept for 24 hours at the room temperature.

### Example 2

Example 2 is the same as Example 1 except that the silane coupling agent is changed to N1-(3-trimethoxysilylpropyl)diethylenetriamine.

### Example 3

Example 3 is the same as Example 1 except that the basic functional group is changed to ethylenediamine.

### Example 4

Example 4 is the same as Example 1 except that the basic functional group is changed to 2-(2-aminoethylamino)ethanol.

### Example 5

Example 5 is the same as Example 1 except that the intermediate membrane is changed to an MFI-type zeolite membrane.

(Formation of Intermediate Membrane (MFI-Type Zeolite Membrane))

A monolith-type alumina porous support is prepared and seed crystals of MFI-type zeolite are deposited on the inner surface of each through hole. Next, by mixing silica, tetrapropylammonium bromide, and water, a starting material solution is prepared. The ratio of silica, tetrapropylammonium bromide, and water is 1:0.25:100 at the molar ratio. After placing the alumina porous support on which the seed crystals of MFI-type zeolite are deposited into the fluororesin inner cylinder (internal volume: 300 ml) of the stainless pressure-resistant container, the above-described starting material solution is put therein and a heat treatment (hydrothermal synthesis at 160° C. for 24 hours) is performed, to thereby form a high silica MFI-type zeolite membrane on the inner surface of the through hole. Next, the alumina support is washed and then dried at 80° C. for 12 hours or more. After that, by raising the temperature of the alumina support to 450° C. in the electric furnace and keeping the temperature thereof for 50 hours, the organic substance (SDA) is burned and removed, and an MFI-type zeolite membrane which is the intermediate membrane is thereby obtained.

### Example 6

Example 6 is the same as Example 5 except that the basic functional group is changed to 2-(2-aminoethylamino)ethanol.

### Example 7

Example 7 is the same as Example 1 except that the intermediate membrane is changed to a BEA-type zeolite membrane.

(Formation of Intermediate Membrane (BEA-Type Zeolite Membrane))

A monolith-type alumina porous support is prepared and seed crystals of BEA-type zeolite are deposited on the inner surface of each through hole. Next, by mixing silica, tetraethylammonium hydroxide, hydrofluoric acid, and water, a starting material solution is prepared. The ratio of silica, tetraethylammonium hydroxide, hydrofluoric acid, and water is 1:0.5:0.5:20 at the molar ratio. After placing the alumina porous support on which the seed crystals of BEA-type zeolite are deposited into the fluororesin inner cylinder (internal volume: 300 ml) of the stainless pressure-resistant container, the above-described starting material solution is put therein and a heat treatment (hydrothermal synthesis at 130° C. for 96 hours) is performed, to thereby form a high silica BEA-type zeolite membrane on the inner surface of the through hole. Next, the alumina support is washed and then dried at 80° C. for 12 hours or more. After that, by raising the temperature of the alumina support to 450° C. in the electric furnace and keeping the temperature thereof for 50 hours, the organic substance (SDA) is burned and removed, and a BEA-type zeolite membrane which is the intermediate membrane is thereby obtained.

### Example 8

Example 8 is the same as Example 1 except that the intermediate membrane is changed to an FAU-type zeolite membrane and the burn and removal condition of CTAB in formation of the mesoporous silica membrane is changed to 300° C.×100 hours.

(Formation of Intermediate Membrane (FAU-Type Zeolite Membrane))

A monolith-type alumina porous support is prepared and seed crystals of FAU-type zeolite are deposited on the inner surface of each through hole. Next, by mixing silica, sodium hydroxide, aluminum hydroxide, and water, a starting material solution is prepared. The ratio of aluminum hydroxide, silica, sodium hydroxide, and water is 1:10:40:200 at the molar ratio. After placing the alumina porous support on which the seed crystals of FAU-type zeolite are deposited into the fluororesin inner cylinder (internal volume: 300 ml) of the stainless pressure-resistant container, the above-described starting material solution is put therein and a heat treatment (hydrothermal synthesis at 80° C. for 10 hours) is performed, to thereby form a high silica FAU-type zeolite membrane on the inner surface of the through hole. After that, the alumina support is washed and then dried at 80° C. for 12 hours or more.

### Example 9

Formation of the intermediate membrane (DDR-type zeolite membrane) is the same as that in Example 1, and the basic functional group is changed to diethylenetriamine and the solvent is changed to water. Further, the temperature in the organic-inorganic hybridization is 80° C.

### Example 10

Example 10 is the same as Example 1 except that the intermediate membrane is changed to a MOF (UiO-66) membrane and the burn and removal condition of CTAB in formation of the mesoporous silica membrane is changed to 300° C.×100 hours.

(Formation of Intermediate Membrane (MOF (UiO-66) Membrane))

ZrCl₄, 1,4-benzenedicarboxylic acid, water, and acetic acid are added to dimethylformamide (DMF). The ratio of ZrCl₄, 1,4-benzenedicarboxylic acid, water, acetic acid, and DMF is 1:1:1:100:200 at the molar ratio, and the mixture is left still at 120° C. for 24 hours. After cooling, washing with DMF is performed, to thereby obtain an object.

Water is added to the obtained UiO-66, to be adjusted to 0.05 wt % aqueous solution, and then pulverizing by a ball mill is performed for one day. A monolith-type alumina porous support is prepared and seed crystals of UiO-66 are deposited on the inner surface of each through hole. ZrCl₄, 1,4-benzenedicarboxylic acid, water, and acetic acid are added to DMF, and the support is immersed in a solution containing ZrCl₄, 1,4-benzenedicarboxylic acid, water, acetic acid, and DMF at the molar ratio of 1:1:1:100:600 at 130° C. for 6 hours. After immersion, the support is washed sequentially with DMF and water.

### Comparative Example 1

Comparative Example 1 is the same as Example 1 except that the zeolite membrane which is the intermediate membrane is not formed.

Next, various measurements and evaluations are performed on the separation membrane complex in each of Examples 1 to 10 and Comparative Example 1.

(Thickness Measurement of Intermediate Membrane and Separation Membrane)

Measurement of the thicknesses of the zeolite membrane (intermediate membrane) and the mesoporous silica membrane (separation membrane) is performed by using the scanning electron microscope (SEM) to image the cross section perpendicular to these membranes. In the separation membrane complex in each of Examples 1 to 10, a mesoporous silica membrane having a uniform thickness of 0.3 μm is formed. On the other hand, in the separation membrane complex of Comparative Example 1, the precursor solution infiltrates into the pores of the support and no membrane is formed on the surface of the support, and poor coverage of the mesoporous silica membrane occurs.

(X-Ray Diffraction Evaluation)

In the X-ray diffraction (XRD) evaluation, an X-ray diffraction apparatus manufactured by Rigaku Corporation (apparatus name: MiniFlex 600) is used. The X-ray diffraction measurement is performed with the condition that the tube voltage is 40 kV, the tube current is 15 mA, the scanning speed is 0.5°/min, and the scanning step is 0.02°. Further, other conditions are that the divergence slit is 1.25°, the scattering slit is 1.25°, the receiving slit is 0.3 mm, the incident solar slit is 5.0°, and the light-receiving solar slit is 5.0°. No monochromator is used, and as a CuKβ ray filter, used is a nickel foil having a thickness of 0.015 mm. After cutting the separation membrane complex at a plane including a central axis of an arbitrary through hole, the surface of the mesoporous silica membrane is irradiated with an X-ray.

In the X-ray diffraction pattern obtained from the separation membrane complex in each of Examples 1 to 10, a peak derived from the mesoporous silica membrane is found in the vicinity of 2θ=3° and a peak derived from the zeolite membrane or the MOF membrane is found at 5° or more. In the X-ray diffraction pattern obtained from the separation membrane complex of Comparative Example 1, no diffraction peak derived from the pores in a range of 1 to 4° is found.

(D-SIMS Evaluation)

In the separation membrane complex in each of Examples 1 to 10, when measurement is performed on the surface of the mesoporous silica membrane by D-SIMS, the concentration of nitrogen (N) element contained in the silane coupling agent gradually decreases (is inclined) from the surface of the mesoporous silica membrane toward the zeolite membrane and becomes almost constant before reaching an interface with the zeolite membrane. In the separation membrane complex in each of Examples 1 to 10, since the mesoporous silica membrane is formed on the zeolite membrane or the MOF membrane, it is presumed that in the hybridization, excessive infiltration of the solution for introduction of the functional group into the pores of the mesoporous silica membrane is suppressed and the concentration of nitrogen element thereby becomes high only in the surface layer of the mesoporous silica membrane. In the separation membrane complex of Comparative Example 1, nitrogen element is detected unevenly in the entire support, and it is thought that the solution for introduction of the functional group infiltrates into the entire support.

(Membrane Performance Evaluation)

Carbon dioxide (CO₂) gas is introduced into the surface of the mesoporous silica membrane at 100° C. with a pressure of 0.3 MPa and the CO₂ permeance is measured. In the separation membrane complex in each of Examples 1 to 10, sufficiently high CO₂ permeance is obtained, as compared with the separation membrane complex of Comparative Example 1.

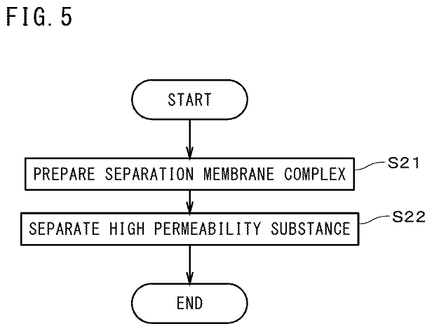

Next, with reference to FIGS. 4 and 5, separation of a mixed substance by using the separation membrane complex 1 will be described. FIG. 4 is a view showing a separation apparatus 2. FIG. 5 is a flowchart showing a flow for separating a mixed substance by the separation apparatus 2.

In the separation apparatus 2, a mixed substance containing a plurality of types of fluids (i.e., gases or liquids) is supplied to the separation membrane complex 1, and a substance with high permeability in the mixed substance is caused to permeate the separation membrane complex 1, to be thereby separated from the mixed substance. Separation in the separation apparatus 2 may be performed, for example, in order to extract a substance with high permeability from a mixed substance, or in order to concentrate a substance with low permeability.

The mixed substance (i.e., mixed fluid) may be a mixed gas containing a plurality of types of gases, may be a mixed liquid containing a plurality of types of liquids, or may be a gas-liquid two-phase fluid containing both a gas and a liquid.

The mixed substance contains at least one type of, for example, hydrogen (H₂), helium (He), nitrogen (N₂), oxygen (O₂), water (H₂O), water vapor (H₂O), carbon monoxide (CO), carbon dioxide (CO₂), nitrogen oxide, ammonia (NH₃), sulfur oxide, hydrogen sulfide (H₂S), sulfur fluoride, mercury (Hg), arsine (AsH₃), hydrogen cyanide (HCN), carbonyl sulfide (COS), C1 to C8 hydrocarbons, organic acid, alcohol, mercaptans, ester, ether, ketone, and aldehyde.

The nitrogen oxide is a compound of nitrogen and oxygen. The above-described nitrogen oxide is, for example, a gas called NOx such as nitric oxide (NO), nitrogen dioxide (NO₂), nitrous oxide (also referred to as dinitrogen monoxide) (N₂O), dinitrogen trioxide (N₂O₃), dinitrogen tetroxide (N₂O₄), dinitrogen pentoxide (N₂O₅), or the like.

The sulfur oxide is a compound of sulfur and oxygen. The above-described sulfur oxide is, for example, a gas called SOₓ such as sulfur dioxide (SO₂), sulfur trioxide (SO₃), or the like.

The sulfur fluoride is a compound of fluorine and sulfur. The above-described sulfur fluoride is, for example, disulfur difluoride (F—S—S—F, S=SF₂), sulfur difluoride (SF₂), sulfur tetrafluoride (SF₄), sulfur hexafluoride (SF₆), disulfur decafluoride (S₂F₁₀), or the like.

The C1 to C8 hydrocarbons are hydrocarbons with not less than 1 and not more than 8 carbon atoms. The C3 to C8 hydrocarbons may be any one of a linear-chain compound, a side-chain compound, and a ring compound. Further, the C2 to C8 hydrocarbons may either be a saturated hydrocarbon (i.e., in which there is no double bond or triple bond in a molecule), or an unsaturated hydrocarbon (i.e., in which there is a double bond and/or a triple bond in a molecule). The C1 to C4 hydrocarbons are, for example, methane (CH₄), ethane (C₂H₆), ethylene (C₂H₄), propane (C₃H), propylene (C₃H₆), normal butane (CH₃(CH₂)₂CH₃), isobutane (CH(CH₃)₃), 1-butene (CH₂═CHCH₂CH₃), 2-butene (CH₃CH═CHCH₃), or isobutene (CH₂═C(CH₃)₂).

The above-described organic acid is carboxylic acid, sulfonic acid, or the like. The carboxylic acid is, for example, formic acid (CH₂O₂), acetic acid (C₂H₄O₂), oxalic acid (C₂H₂O₄), acrylic acid (C₃H₄O₂), benzoic acid (C₆H₅COOH), or the like. The sulfonic acid is, for example, ethanesulfonic acid (C₂H₆O₃S) or the like. The organic acid may either be a chain compound or a ring compound.

The above-described alcohol is, for example, methanol (CH₃OH), ethanol (C₂H₅OH), isopropanol (2-propanol) (CH₃CH(OH)CH₃), ethylene glycol (CH₂(OH)CH₂(OH)), butanol (C₄H₉OH), or the like.

The mercaptans are an organic compound having hydrogenated sulfur (SH) at the terminal end thereof, and are a substance also referred to as thiol or thioalcohol. The above-described mercaptans are, for example, methyl mercaptan (CH₃SH), ethyl mercaptan (C₂H₅SH), 1-propanethiol (C₃H₇SH), or the like.

The above-described ester is, for example, formic acid ester, acetic acid ester, or the like.

The above-described ether is, for example, dimethyl ether ((CH₃)₂O), methyl ethyl ether (C₂H₅OCH₃), diethyl ether ((C₂H₅)₂O), or the like.

The above-described ketone is, for example, acetone ((CH₃)₂CO), methyl ethyl ketone (C₂H₅COCH₃), diethyl ketone ((C₂H₅)₂CO), or the like.

The above-described aldehyde is, for example, acetaldehyde (CH₃CHO), propionaldehyde (C₂H₅CHO), butanal (butylaldehyde) (C₃H₇CHO), or the like.

In the following description, it is assumed that the mixed substance separated by the separation apparatus 2 is a mixed gas containing a plurality of types of gases.

The separation apparatus 2 includes the separation membrane complex 1, sealing parts 21, a housing 22, two sealing members 23, a supply part 26, a first collecting part 27, and a second collecting part 28. The separation membrane complex 1, the sealing parts 21, and the sealing members 23 are placed inside the housing 22. The supply part 26, the first collecting part 27, and the second collecting part 28 are disposed outside the housing 22 and connected to the housing 22.

The sealing parts 21 are members which are attached to both end portions in the longitudinal direction (i.e., in the left and right direction of FIG. 4) of the support 11 and cover and seal both end surfaces in the longitudinal direction of the support 11 and outer surfaces in the vicinity of the end surfaces. The sealing parts 21 prevent inflow and outflow of a gas from both the end surfaces of the support 11. The sealing part 21 is, for example, a plate-like member formed of glass or a resin. The material and the shape of the sealing part 21 may be changed as appropriate. Further, since the sealing part 21 is formed with a plurality of openings which coincide with the plurality of through holes 111 of the support 11, both ends of each through hole 111 of the support 11 in the longitudinal direction are not covered by the sealing parts 21. Therefore, the gas or the like can flow into and out from the through hole 111 from both ends thereof.

There is no particular limitation on the shape of the housing 22 but is, for example, a tubular member having a substantially cylindrical shape. The housing 22 is formed of, for example, stainless steel or carbon steel. The longitudinal direction of the housing 22 is substantially in parallel to the longitudinal direction of the separation membrane complex 1. A supply port 221 is provided at an end portion on one side in the longitudinal direction of the housing 22 (i.e., an end portion on the left side in FIG. 4), and a first exhaust port 222 is provided at another end portion on the other side. A second exhaust port 223 is provided on a side surface of the housing 22. The supply part 26 is connected to the supply port 221. The first collecting part 27 is connected to the first exhaust port 222. The second collecting part 28 is connected to the second exhaust port 223. An internal space of the housing 22 is an enclosed space that is isolated from the space around the housing 22.

The two sealing members 23 are arranged around the entire circumference between an outer surface of the separation membrane complex 1 and an inner surface of the housing 22 in the vicinity of both end portions of the separation membrane complex 1 in the longitudinal direction. Each of the sealing members 23 is a substantially annular member formed of a material that the gas cannot permeate. The sealing member 23 is, for example, an O-ring formed of a flexible resin. The sealing members 23 come into close contact with the outer surface of the separation membrane complex 1 and the inner surface of the housing 22 around the entire circumferences thereof. In the exemplary case of FIG. 4, the sealing members 23 come into close contact with outer surfaces of the sealing parts 21 and indirectly come into close contact with the outer surface of the separation membrane complex 1 with the sealing parts 21 interposed therebetween. The portions between the sealing members 23 and the outer surface of the separation membrane complex 1 and between the sealing members 23 and the inner surface of the housing 22 are sealed, and it is thereby mostly or completely impossible for the gas to pass through the portions.

The supply part 26 supplies the mixed gas into the internal space of the housing 22 through the supply port 221. The supply part 26 includes, for example, a blower or a pump for pumping the mixed gas toward the housing 22. The blower or the pump includes a pressure regulating part for regulating the pressure of the mixed gas to be supplied to the housing 22. The first collecting part 27 and the second collecting part 28 each include, for example, a storage container for storing the gas led out from the housing 22 or a blower or a pump for transporting the gas.

When separation of the mixed gas is performed, the above-described separation apparatus 2 is prepared and the separation membrane complex 1 is thereby prepared (Step S31). Subsequently, the supply part 26 supplies a mixed gas containing a plurality of types of gases with different permeabilities for the laminated membrane 10 (actually, adsorptivities for the functional group introduced into the separation membrane 13) into the internal space of the housing 22. For example, the main component of the mixed gas includes CO₂ and CH₄. The mixed gas may contain any gas other than CO₂ or CH₄. The pressure (i.e., feed pressure) of the mixed gas to be supplied into the internal space of the housing 22 from the supply part 26 is, for example, 0.1 MPa to 20.0 MPa. The temperature for separation of the mixed gas is, for example, 10° C. to 150° C.

The mixed gas supplied from the supply part 26 into the housing 22 is fed from the left end of the separation membrane complex 1 in this figure into the inside of each through hole 111 of the support 11 as indicated by an arrow 251. Gas with high permeability (which is, for example, CO₂, and hereinafter is referred to as a “high permeability substance”) in the mixed gas permeates the laminated membrane 10 formed on the inner surface of each through hole 111 and the support 11, and is led out from the outer surface of the support 11. The high permeability substance is thereby separated from gas with low permeability (which is, for example, CH₄, and hereinafter is referred to as a “low permeability substance”) in the mixed gas (Step S32). The gas (hereinafter, referred to as a “permeate substance”) led out from the outer surface of the support 11 is collected by the second collecting part 28 through the second exhaust port 223 as indicated by an arrow 253. The pressure (i.e., permeate pressure) of the gas to be collected by the second collecting part 28 through the second exhaust port 223 is, for example, about 1 atmospheric pressure (0.101 MPa).

Further, in the mixed gas, a gas (hereinafter, referred to as a “non-permeate substance”) other than the gas which has permeated the laminated membrane 10 and the support 11 passes through each through hole 111 of the support 11 from the left side to the right side in this figure and is collected by the first collecting part 27 through the first exhaust port 222 as indicated by an arrow 252. The pressure of the gas to be collected by the first collecting part 27 through the first exhaust port 222 is, for example, substantially the same as the feed pressure. The non-permeate substance may include a high permeability substance that has not permeated the laminated membrane 10, as well as the above-described low permeability substance.

In the above-described separation membrane complex 1 and the above-described method of producing the separation membrane complex 1, various modifications can be made.

In the separation membrane complex 1, the average pore diameter of the intermediate membrane 12 may be larger than 1.0 nm. The average pore diameter of the separation membrane 13 may be smaller than 0.5 nm, or may be larger than 10.0 nm. The thickness of the intermediate membrane 12 may be larger than 5 μm, and the thickness of the separation membrane 13 may be larger than 1 km.

In the support 11 having the through holes, the laminated membrane 10 may be formed on either one of the inner surface and the outer surface thereof or both of the inner surface and the outer surface thereof.

The separation membrane complex 1 may be produced by any method other than the above-described production method.

In the separation apparatus 2 and the separation method, any substance other than the substances exemplarily shown in the above description may be separated from the mixed substance.

The configurations in the above-described preferred embodiment and variations may be combined as appropriate only if those do not conflict with one another.

While the invention has been shown and described in detail, the foregoing description is in all aspects illustrative and not restrictive. It is therefore understood that numerous modifications and variations can be devised without departing from the scope of the invention.

### INDUSTRIAL APPLICABILITY

The separation membrane complex of the present invention can be used, for example, as a separation membrane for carbon dioxide, and can be further used in various fields, as a separation membrane for any of various substances other than carbon dioxide, an adsorption membrane for any of various substances, or the like.

### REFERENCE SIGNS LIST

1 Separation membrane complex
11 Support
12 Intermediate membrane
13 Separation membrane
14 Functional group introduction layer
S11 to S14, S31, S32 Step

1. A separation membrane complex, comprising:
a porous support;
an intermediate membrane which is a polycrystalline membrane formed on a surface of said support and has pores originated from a framework structure, said pores having an average pore diameter smaller than that of pores in vicinity of said surface of said support; and
a separation membrane which is formed on said intermediate membrane and is an inorganic membrane having a regular pore structure,
wherein a functional group is introduced into pores of a surface layer in said separation membrane, said surface layer being away from said intermediate membrane.

2. The separation membrane complex according to claim 1, wherein
the average pore diameter of said intermediate membrane is 0.1 to 1.0 nm, an average pore diameter of said separation membrane is 0.5 to 10.0 nm, and the average pore diameter of said intermediate membrane is smaller than that of said separation membrane.

3. The separation membrane complex according to claim 1, wherein
said intermediate membrane is a membrane composed of zeolite or metal organic framework.

4. The separation membrane complex according to claim 1, wherein
said separation membrane is a membrane composed of mesoporous material, zeolite, or metal organic framework.

5. The separation membrane complex according to claim 1, wherein
in an X-ray diffraction pattern obtained by X-ray irradiation onto a surface of said separation membrane, a peak appears in a range of 26=1 to 4°.

6. The separation membrane complex according to claim 1, wherein
a thickness of said intermediate membrane is not larger than 5 μm and that of said separation membrane is not larger than 1 μm.

7. The separation membrane complex according to claim 1, wherein
said functional group is an amino group.

8. A method of producing a separation membrane complex, comprising:
a) preparing a porous support;
b) forming an intermediate membrane on a surface of said support, said intermediate membrane being a polycrystalline membrane and having pores originated from a framework structure, said pores having an average pore diameter smaller than that of pores in vicinity of said surface of said support;
c) forming a separation membrane on said intermediate membrane, said separation membrane being an inorganic membrane having a regular pore structure; and
d) introducing a functional group into pores of a surface layer in said separation membrane by supplying a predetermined solution to said separation membrane, said surface layer being away from said intermediate membrane,
wherein said intermediate membrane has impermeability to a precursor solution used for forming said separation membrane in said operation c) and said predetermined solution used in said operation d).
